(19) United States
(12) Patent Application Publication
(10) Pub. No.: US 2026/0279338 A1
(43) Pub. Date: Sep. 17, 2026

(54) INVERSE TEXT NORMALIZATION MODEL TRAINING DATA GENERATION METHOD AND APPARATUS BY USING TEXT TO SPEECH AND SPEECH TO TEXT

(71) Applicant: LLSOLLU CO., LTD, Seoul (KR)

(72) Inventors: Youngdae OH, Seoul (KR); Myeongjin HWANG, Seoul (KR); Jongwook MOON, Seoul (KR)

(21) Appl. No.: 19/048,117

(22) Filed: Feb. 7, 2025

(30) Foreign Application Priority Data
Dec. 8, 2023 (KR) 10-2023-0177483

(51) Int. Cl. G10L 15/06; G06F 40/166; G10L 13/00; G10L 15/26

(52) U.S. Cl. CPC G10L 15/063; G06F 40/166; G10L 13/00; G10L 15/26

(57) ABSTRACT

A method for generating training data for an inverse text normalization model according to a first aspect of the present invention, the method comprises: converting original text data into speech data using TTS (text to speech), converting the speech data into text data using STT (speech to text), and generating training data for the inverse text normalization model based on the original text data and the text data.

### TECHNICAL FIELD

An embodiment relates to a method and apparatus for generating training data for an inverse text normalization model using TTS (text to speech) and STT (speech to text).

### BACKGROUND

Inverse Text Normalization (ITN) technology is one of the post-processing technologies for speech recognition results, which appropriately converts text including a first character set included in the speech recognition results into a second character set, symbols, numbers, and the like. Herein, the first character set may be Korean, and the second character set may be characters other than Korean, such as Roman letters, Chinese characters, and the like.

Methods for performing inverse text normalization include a method of embedding an inverse text normalization function in a speech recognition model itself, a deep learning-based inverse text normalization method, and a rule-based inverse text normalization method.

Among these, the deep learning-based inverse text normalization method has advantages such as high accuracy, applicability to a general-purpose domain or a wide range of patterns, and no need for rule control as it learns through training, but it has a disadvantage in that it requires a large amount of training data and many hardware resources such as GPUs.

In other words, the deep learning-based inverse text normalization method may provide high-quality inverse text normalization results that are widely applicable, but on the premise that training data for the inverse text normalization model, composed of text before inverse text normalization as input and text after inverse text normalization as output, needs to be built on a large scale to ensure such quality.

Furthermore, there is a problem in that building a large amount of training data for the inverse text normalization model may be costly and time-consuming.

### SUMMARY OF THE INVENTION

### Problem to be Solved

An object to be solved by an embodiment is to provide a method and apparatus capable of automatically generating high-quality parallel data for training an inverse text normalization model using STT (speech to text) and TTS (text to speech).

However, the problems to be solved by an embodiment are not limited to those described above, and other problems to be solved not mentioned will be clearly understood by one of ordinary skill in the art to which an embodiment pertains from the following description.

### Solution to the Problem

In accordance with an embodiment of a first aspect of the present invention, a method for generating training data for an inverse text normalization model comprises converting original text data into speech data using TTS (text to speech), converting the speech data into text data using STT (speech to text), and generating training data for the inverse text normalization model based on the original text data and the text data.

The original text data may include at least one of a second character set, numbers, and symbols.

The text data may include a first character set different from the second character set.

The generating the training data may include generating parallel data based on the original text data and the text data.

The inverse text normalization model may be a model trained, using the text data as input and the original text data as label data, to convert a character in the text data into a second character set, a number, or a symbol.

In accordance with another embodiment of the first aspect of the present invention, a method for training an inverse text normalization model comprises converting original text data into speech data using TTS, converting the speech data into text data using STT, generating training data for the inverse text normalization model based on the original text data and the text data, and training the inverse text normalization model based on the generated training data.

The generating the training data includes generating parallel data based on the original text data and the text data.

The inverse text normalization model may be a model trained, using the text data as input and the original text data as label data, to convert a predetermined character in the text data into a second character set, a number, or a symbol.

In accordance with a second aspect of the present invention, an apparatus for generating training data comprises at least one memory capable of storing computer-executable instructions, and a processor that, by executing the instructions, converts original text data into speech data using TTS (text to speech), converts the speech data into text data using STT (speech to text), and generates the training data for the inverse text normalization model based on the original text data and the text data.

In accordance with a third aspect of the present invention, there is provided a non-transitory computer-readable storage medium storing computer-executable instructions that, when executed by a processor, cause the processor to perform a method comprising: converting original text data into speech data using TTS (text to speech); converting the speech data into text data using STT (speech to text); and generating training data for an inverse text normalization model based on the original text data and the text data.

In accordance with a forth aspect of the present invention, there is provided a computer program stored on a non-transitory computer-readable storage medium, the computer program comprising instructions which, when executed by a processor, cause the processor to perform a method comprising: converting original text data into speech data using TTS (text to speech); converting the speech data into text data using STT (speech to text); and generating training data for an inverse text normalization model based on the original text data and the text data.

### Effects of the Invention

According to an embodiment, high-quality parallel data for training an inverse text normalization model may be automatically generated while requiring less cost and time.

The effects obtainable through the embodiments are not limited to the effects described above, and other effects not mentioned will be clearly understood by one of ordinary skill in the art to which the present disclosure pertains from the following description.

### BRIEF DESCRIPTION OF THE DRAWINGS

FIG. 1 is a flowchart illustrating a method for generating training data for an inverse text normalization model according to a first aspect of the present invention.

FIG. 2 is a block diagram illustrating an apparatus for generating training data for an inverse text normalization model according to a third aspect of the present invention.

FIG. 3 is a block diagram illustrating functions of a program for generating training data for an inverse text normalization model.

FIG. 4 is an exemplary diagram illustrating an inverse text normalization method performed by an inverse text normalization model trained according to an embodiment.

FIGS. 5 and 6 are exemplary diagrams illustrating in detail an example of a method for generating training data for an inverse text normalization model according to the first aspect of the present invention.

### DETAILED DESCRIPTION

Advantages and features of an embodiment, and methods of achieving them, will become clear with reference to the embodiments described below in detail along with the accompanying drawings. However, the disclosed embodiments are not to be construed as limiting and may be implemented in various different forms. These embodiments are provided only to make the disclosure complete and to fully inform one of ordinary skill in the art of the scope of the invention, and the scope of the invention is only defined by the claims.

In describing the embodiments, when it is determined that a detailed description of a known function or configuration may unnecessarily obscure the subject matter of an embodiment, the detailed description thereof will be omitted. The terms used hereinafter are defined in consideration of the functions in the embodiments and may vary depending on the intention of a user or an operator, or customs. Therefore, the definitions should be made based on the content throughout this specification.

Hereinafter, the terms used in this specification will be briefly described, and an embodiment will be described in detail.

The terms used in this specification have been selected from currently widely used general terms, considering the functions of an embodiment, but this may vary depending on the intention of a person skilled in the art, legal precedents, or the emergence of new technologies. Furthermore, in some cases, there are terms arbitrarily selected by the applicant, in which case the meaning will be described in detail in the corresponding description part of the invention. Therefore, the terms used in an embodiment should be defined based on the meaning of the terms and the overall content of an embodiment, not just the names of the terms.

Throughout the specification, when a part is said to “include” a certain component, it means that it may further include other components, not excluding other components, unless there is a specific contrary statement.

Furthermore, the term “unit” as used in the specification refers to a software or hardware component such as an FPGA or ASIC, and the “unit” performs certain roles. However, “unit” is not limited to software or hardware. A “unit” may be configured to be in an addressable storage medium and may be configured to reproduce one or more processors. Thus, as an example, a “unit” includes components such as software components, object-oriented software components, class components, and task components, and processes, functions, attributes, procedures, subroutines, segments of program code, drivers, firmware, microcode, circuits, data, databases, data structures, tables, arrays, and variables. Functions provided in the components and “units” may be combined into a smaller number of components and “units” or may be further separated into additional components and “units”.

Hereinafter, embodiments will be described in detail with reference to the accompanying drawings so that one of ordinary skill in the art to which an embodiment pertains may easily carry out the invention.

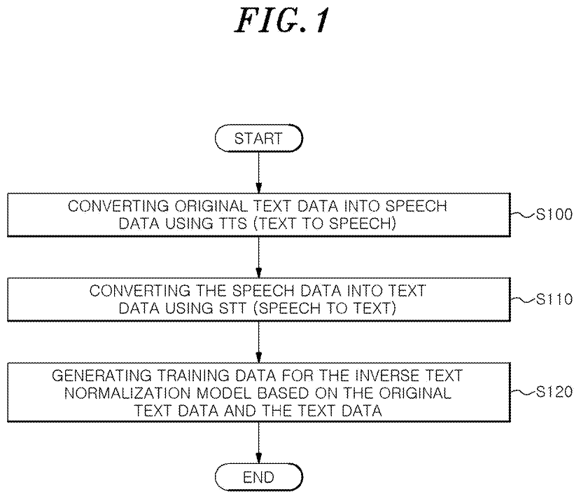

FIG. 1 is a flowchart illustrating a method for generating training data for an inverse text normalization model according to a first aspect of the present invention.

Hereinafter, the method for generating training data for an inverse text normalization model will be described on the premise that the method is performed by an apparatus for generating training data.

As shown in FIG. 1, a method for generating training data for an inverse text normalization model according to a first aspect of the present invention comprises converting original text data into speech data using TTS (text to speech) (S100), converting the speech data into text data using STT (speech to text) (S110), and generating training data for the inverse text normalization model based on the original text data and the text data (S120).

An Inverse Text Normalization (ITN) method may refer to a speech recognition post-processing method. The inverse text normalization method may appropriately convert text including a first character set in a speech recognition result into symbols, Arabic numerals, etc., according to the context. At this time, the first character set may be Korean, but is not limited to such.

Methods for performing inverse text normalization may include a deep learning-based inverse text normalization method and a rule-based inverse text normalization method. At this time, inverse text normalization may also be performed by using the deep learning-based inverse text normalization method and the rule-based inverse text normalization method together.

Speech recognition may refer to STT (speech to text) technology, but is not limited thereto.

An inverse text normalization model may refer to a model pre-trained to perform an inverse text normalization task based on deep learning.

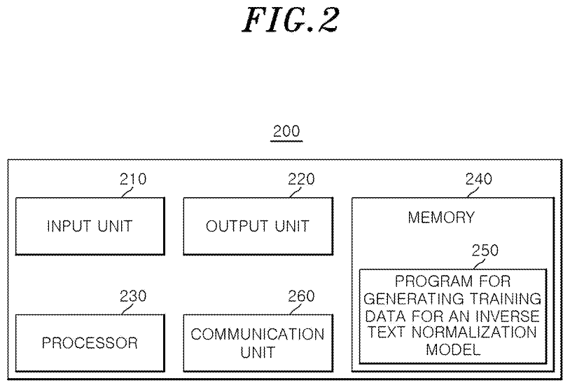

FIG. 2 is a block diagram illustrating an apparatus for generating training data for an inverse text normalization model according to a second aspect of the present invention.

As shown in FIG. 2, an apparatus for generating training data for an inverse text normalization model 200 may include an input unit 210, an output unit 220, a processor 230, a memory 240, and a communication unit 260.

Hereinafter, for convenience of description, it is described as an example that the apparatus for generating training data for an inverse text normalization model 200 includes the input unit 210, the output unit 220, the processor 230, the memory 240, and the communication unit 260, but it is not limited thereto. That is, each unit component may be provided outside the apparatus for generating training data for an inverse text normalization model 200 and operate in a manner that interacts with the apparatus for generating training data for an inverse text normalization model 200.

The input unit 210 may include a user interface that receives a command, information, or the like used to control the apparatus for generating training data for an inverse text normalization model 200. Furthermore, the input unit 210 may be a hardware device (e.g., a keyboard, a touch pad, a voice recognition microphone, etc.) that may directly receive a command, information, or the like used to control the apparatus for generating training data for an inverse text normalization model 200.

In one embodiment, the input unit 210 may receive information necessary for generating training data for an inverse text normalization model from a user.

The output unit 220 may provide information necessary for generating training data for an inverse text normalization model, original text data, text data, and information including the generated training data of the inverse text normalization model to a user as visual information through an interface or a display device.

The processor 230 may generally control the operation of the apparatus for generating training data for an inverse text normalization model 200 to perform an embodiment.

The processor 230 may load a program for generating training data for an inverse text normalization model 250 and information necessary for executing the program for generating training data for an inverse text normalization model 250 from the memory 240 in order to execute the program for generating training data for an inverse text normalization model 250.

The processor 230 may control to store data received from an external device via the communication unit 260 in the memory 240. Furthermore, the processor 230 may control to transmit information necessary for generating training data for an inverse text normalization model, original text data, text data, and information including the generated training data of the inverse text normalization model to an external device via the communication unit 260.

The processor 230 may refer to a processing device such as a microprocessor, a central processing unit (CPU), a graphic processing unit (GPU), a processor core, a multiprocessor, an application-specific integrated circuit (ASIC), a field programmable gate array (FPGA), or a micro controller unit (MCU), but is not limited to the above-mentioned embodiments.

The memory 240 may store the program for generating training data for an inverse text normalization model 250 and information necessary for executing the program for generating training data for an inverse text normalization model 250. Furthermore, the memory 240 may also store the processing result by the processor 230.

The program for generating training data for an inverse text normalization model 250 may refer to software including instructions programmed to perform the method according to an embodiment.

The memory 240 may store information necessary for generating training data for an inverse text normalization model, original text data, text data, and information including the generated training data of the inverse text normalization model. Furthermore, the memory 240 may store information received from an external device via the communication unit 260.

The memory 240 may refer to a computer-readable recording medium such as magnetic media like a hard disk, a floppy disk, and a magnetic tape, optical media like a CD-ROM and a DVD, magneto-optical media like a floptical disk, and a hardware device specially configured to store and execute program instructions like a flash memory, but is not limited to the above-mentioned embodiments.

The communication unit 260 may be a wireless communication module capable of performing wireless communication by adopting a communication method such as CDMA, GSM, W-CDMA, TD-SCDMA, WiBro, LTE, EPC, 5G, wireless LAN, Wi-Fi, Bluetooth, Zigbee, Wi-Fi Direct (WFD), Ultra Wide Band (UWB), Infrared Data Association (IrDA), Bluetooth Low Energy (BLE), or Near Field Communication (NFC), but is not limited to the above-mentioned embodiments.

Furthermore, information input and output through the input unit 210 and the output unit 220, information stored in the memory 240, and information transmitted and received through the communication unit 260 include all information related to an embodiment, and are not limited to the above-mentioned embodiments.

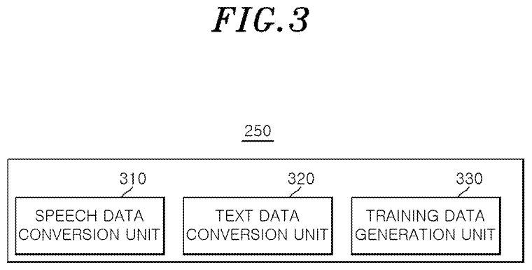

The function or operation of the program for generating training data for an inverse text normalization model 250 will be examined in detail through FIG. 3.

FIG. 3 is a block diagram illustrating functions of a program for generating training data for an inverse text normalization model.

As shown in FIG. 3, the program for generating training data for an inverse text normalization model 250 may include a speech data conversion unit 310, a text data conversion unit 320, and a training data generation unit 330. The speech data conversion unit 310, the text data conversion unit 320, and the training data generation unit 330 are exemplary divisions of the functions of the program for generating training data for an inverse text normalization model 250, and are not limited thereto.

According to embodiments, the respective functions of the speech data conversion unit 310, the text data conversion unit 320, and the training data generation unit 330 may be merged or separated, and may be implemented as a series of instructions included in at least one program.

The speech data conversion unit 310, the text data conversion unit 320, and the training data generation unit 330 may be implemented by the processor 230, and may refer to a data processing device embedded in hardware, having a physically structured circuit to perform functions represented by code or instructions included in the program for generating training data for an inverse text normalization model 250 stored in the memory 240.

The speech data conversion unit 310 may convert the original text data into speech data using TTS (text to speech).

The text data conversion unit 320 may convert the speech data into text data using STT (speech to text).

The training data generation unit 330 may generate training data for the inverse text normalization model based on the original text data and the text data.

The training data generation unit 330 may generate parallel data based on the original text data and the text data. At this time, the original text data may include at least one of a second character set, a number, and a symbol. Furthermore, the text data may not include the second character set, the number, and the symbol. Therefore, the parallel data may be data including text data that includes at least one of the second character set, the number, and the symbol, and text data that does not include the second character set, the number, and the symbol.

The inverse text normalization model may be a model trained to convert a predetermined character in the text data into a second character set, a number, or a symbol, using the text data as input and the original text data as label data.

Since the text data used as input data may not include the second character set, the number, and the symbol, and the original text data used as label data may include at least one of the second character set, the number, and the symbol, the parallel data including the original text data and the text data may be provided to the inverse text normalization model as training data/answer data.

The parallel data generated by the above-described method may be used to train the inverse text normalization model.

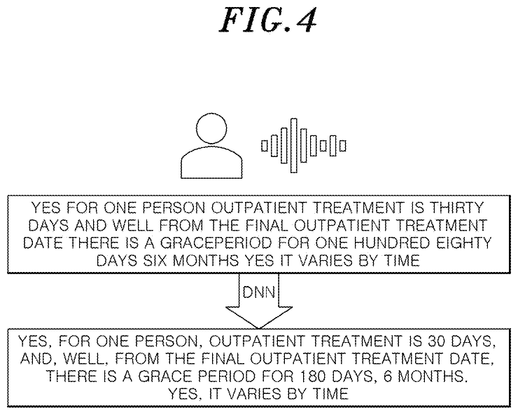

FIG. 4 is an exemplary diagram illustrating an inverse text normalization method performed by an inverse text normalization model trained according to an embodiment.

As shown in FIG. 4, an inverse text normalization apparatus may receive text data converted through speech recognition from speech data of “Yes for one person outpatient treatment is thirty days and well from the final outpatient treatment date there is a graceperiod for one hundred eighty days six months Yes it varies by time”.

The inverse text normalization apparatus may output final inverse normalized data of “Yes, for one person, outpatient treatment is 30 days, and, well, from the final outpatient treatment date, there is a grace period for 180 days, 6 months. Yes, it varies by time.” for the input text data through an inverse text normalization method.

That is, the inverse text normalization apparatus may convert a predetermined text in an inverse normalization area of the input text into a number by converting “thirty days” to “30 days” and “one hundred eighty days six months” to “180 days 6 months” through the inverse text normalization method.

Furthermore, the inverse text normalization apparatus may correct the spacing of a predetermined text, for example, by converting the string “graceperiod” into “grace period” and “Yes it varies by time” to “Yes, it varies by time” through the inverse text normalization method.

At this time, the inverse text normalization method may include a method of performing the inverse text normalization method using a pre-trained inverse text normalization model that performs an inverse text normalization task or a pre-inputted rule.

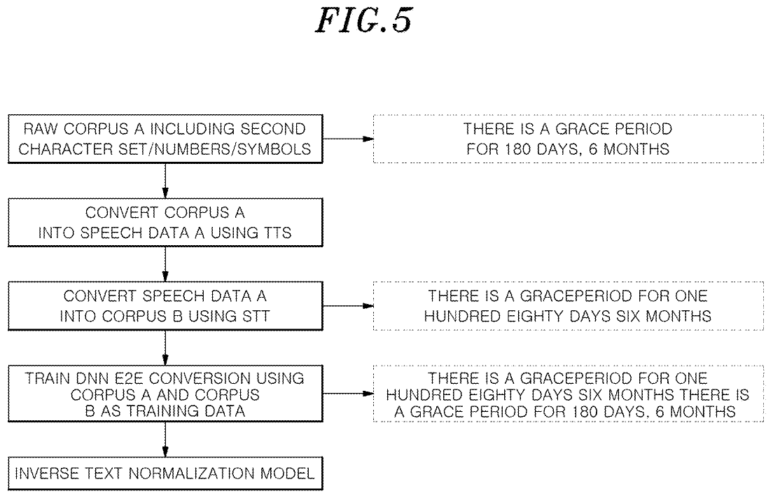

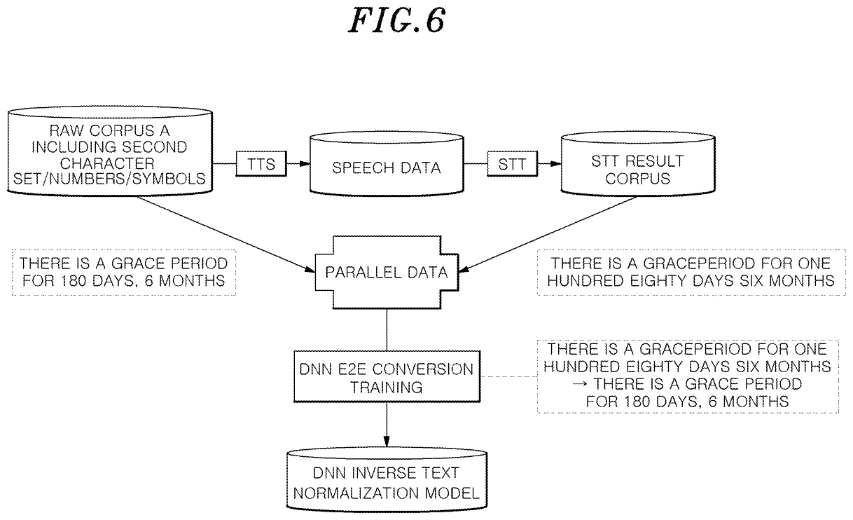

FIGS. 5 and 6 are exemplary diagrams illustrating in detail an example of a method for generating training data for an inverse text normalization model according to the first aspect of the present invention.

A deep learning-based inverse text normalization method may provide widely applicable, high-quality inverse normalization results, but on the premise that training data for the inverse text normalization model, composed of text before inverse text normalization as input and text after inverse text normalization as output, needs to be built on a large scale to ensure such quality.

To solve this problem, a method capable of automatically generating high-quality parallel data for training an inverse text normalization model using STT and TTS may be provided through the method for generating training data for an inverse text normalization model of FIGS. 5 and 6.

The initial input data may be a raw corpus that includes a second character set/numbers/symbols. According to FIGS. 5 and 6, the initial input data is “There is a grace period for 180 days, 6 months”. At this time, the initial input data may be the original text data. That is, the original text data may be a raw corpus that includes a second character set, numbers, or symbols. At this time, the second character set may be characters other than Korean, such as Roman letters or Chinese characters, but is not limited thereto.

The original text data may be converted into speech data using TTS.

The speech data converted using TTS may be converted into text data using STT. According to FIGS. 5 and 6, the text data converted using STT is “There is a graceperiod for one hundred eighty days six months”. Accordingly, STT result data expressed in a first character set may be generated from speech data including a second character set, numbers, or symbols. That is, the text data may be STT result data.

Accordingly, parallel data may be generated by merging the original text data and the text data.

At this time, the parallel data may be generated by interchanging an order of the original text data and the text data. According to FIGS. 5 and 6, the parallel data generated by interchanging the order of the original text data and the text data is shown. That is, the text data not including the second character set, numbers, and symbols may be placed at the front, and the original text data including at least one of the second character set, numbers, and symbols may be placed at the back. Accordingly, training data for the inverse text normalization model, which is a model trained to convert a predetermined character in the text data into a second character set, a number, or a symbol using the text data as input and the original text data as label data, may be generated.

The training data generated by the above-described method may be used for training the inverse text normalization model.

As described above, according to an embodiment, high-quality parallel data for training an inverse text normalization model may be automatically generated while requiring less cost and time.

The combinations of each block in the attached block diagrams and each step in the flowcharts may also be performed by computer program instructions. These computer program instructions may be loaded into an encoding processor of a general-purpose computer, a special-purpose computer, or other programmable data processing equipment, so that the instructions performed by the encoding processor of the computer or other programmable data processing equipment create a means for performing the functions described in each block of the block diagrams or each step of the flowcharts. These computer program instructions may also be stored in a computer-usable or computer-readable memory that may direct a computer or other programmable data processing equipment to implement functions in a specific way, so that the instructions stored in the computer-usable or computer-readable memory may also produce an article of manufacture containing instruction means for performing the functions described in each block of the block diagrams or each step of the flowcharts. The computer program instructions may also be loaded onto a computer or other programmable data processing equipment, so that a series of operational steps are performed on the computer or other programmable data processing equipment to create a computer-executed process, so that the instructions that execute the computer or other programmable data processing equipment may also provide steps for executing the functions described in each block of the block diagrams and each step of the flowcharts.

Furthermore, each block or each step may represent a part of a module, segment, or code including one or more executable instructions for executing a specified logical function(s). In some embodiments, it is also possible that functions mentioned in the blocks or steps occur out of order. For example, two blocks or steps shown in succession may in fact be performed substantially simultaneously, or the blocks or steps may sometimes be performed in reverse order depending on the corresponding function.

The foregoing description is merely an exemplary description of the technical spirit of an embodiment, and various modifications and variations will be possible for one of ordinary skill in the art to which an embodiment pertains without departing from the essential qualities of an embodiment. Therefore, the embodiments disclosed herein are not intended to limit the technical spirit of an embodiment but to describe it, and the scope of the technical spirit of an embodiment is not limited by these embodiments. The scope of protection of an embodiment should be interpreted by the following claims, and all technical ideas within the equivalent scope should be interpreted as being included in the scope of rights of an embodiment.

1. A method for generating training data for an inverse text normalization model, to be performed by an apparatus for generating training data, the method comprising:
converting original text data into speech data using TTS (text to speech);
converting the speech data into text data using STT (speech to text); and
generating training data for the inverse text normalization model based on the original text data and the text data.

2. The method of claim 1, wherein the original text data includes at least one of a second character set, a number, or a symbol.

3. The method of claim 2, wherein the text data includes a first character set different from the second character set.

4. The method of claim 1, wherein generating the training data includes generating parallel data based on the original text data and the text data.

5. The method of claim 1, wherein the inverse text normalization model is a model trained, using the text data as input and the original text data as label data, to convert a character in text data into a second character set, a number, or a symbol.

6. A method for training an inverse text normalization model, to be performed by an apparatus for training an inverse text normalization model, the method comprising:
converting original text data into speech data using TTS (text to speech);
converting the speech data into text data using STT (speech to text);
generating training data for the inverse text normalization model based on the original text data and the text data; and
training the inverse text normalization model based on the generated training data.

7. The method of claim 6, wherein generating the training data includes generating parallel data based on the original text data and the text data.

8. The method of claim 6, wherein the inverse text normalization model is a model trained, using the text data as input and the original text data as label data, to convert a predetermined character in text data into a second character set, a number, or a symbol.

9. An apparatus for generating training data for an inverse text normalization model, comprising:
at least one memory configured to store computer-executable instructions; and
a processor configured to, by executing the instructions,
convert original text data into speech data using TTS (text to speech),
convert the speech data into text data using STT (speech to text), and
generate the training data for the inverse text normalization model based on the original text data and the text data.

10. A non-transitory computer-readable storage medium storing computer-executable instructions, wherein the computer-executable instructions, when executed by a processor, cause the processor to perform the method of claim 1.

11. A computer program including computer-executable instructions stored in a non-transitory computer-readable storage medium, wherein the computer-executable instructions, when executed by a processor, cause the processor to perform the method of claim 1.
